(19) United States
(12) Patent Application Publication
(10) Pub. No.: US 2016/0369657 A1
(43) Pub. Date: Dec. 22, 2016

(54) INSERT FOR TURBOCHARGER SUPPORT HOUSING

(71) Applicant: Caterpillar Inc., Peoria, IL (US)

(72) Inventors: Robert E. Sharp, Corinth, MS (US); Jacob P. Fabrizius, Corinth, MS (US); Jeremiah Keltner, Galesburg, IL (US); Timothy S. Graham, Golden, IL (US); Bharat K. Meduru, Dunlap, IL (US)

(73) Assignee: Caterpillar Inc., Peoria, IL (US)

(21) Appl. No.: 14/740,446

(22) Filed: Jun. 16, 2015

(51) Int. Cl. F01D 25/28

(52) U.S. Cl. CPC F01D 25/28; F05D 2220/40; F05D 2240/90; F05D 2230/80

(57) ABSTRACT

An insert for a turbocharger support housing is provided. The insert includes a main body having a first surface and a second surface. The first and second surfaces define a thickness of the main body therebetween. The main body is configured to mate with a wear prone surface of the turbocharger support housing. The insert also includes a plurality of projections extending from the second surface. Each of the plurality of projections has an opening communicating with the first surface and a bottom end of the projection, such that each of the plurality of projections is configured to correspond with a mounting bore on the wear prone surface.

### TECHNICAL FIELD

The present disclosure relates to an insert for a support housing, and more particularly to an insert used to repair a portion of a turbocharger support housing.

### BACKGROUND

An engine system generally includes a turbocharger associated therewith. The turbocharger is employed to increase an efficiency of the engine system, and is fixedly supported by a turbocharger support housing. The turbocharger generally includes rotating components, such as a turbine wheel and compressor wheel. During operation, the rotating components of the turbocharger create vibrations. These vibrations are transferred to the turbocharger support housing and can cause wear or damage to some portions of the turbocharger support housing. The worn out surfaces of the turbocharger support housing may be unable to provide adequate support to the turbocharger supported thereon. Thus, the turbocharger support housing may need to be repaired or replaced to ensure continued operation of the turbocharger. Replacement of the entire support housing can lead to an increase in overall costs associated with the turbocharger, and repairing the mounting surfaces with known processes can be difficult due to the various complicated surfaces requiring repair.

U.S. Pat. No. 7,311,493 describes a metal sheet that includes means for fixing it to a support and a seal gasket laid out along these means. The fixing means comprise at least one lumen provided on the metal sheet by punching, with a cavity for receiving a head of a fixing component corresponding to a metal sheet portion protruding on the opposite face and a washer for transferring stresses between the metal sheet and the support on said protruding portion.

### SUMMARY OF THE DISCLOSURE

In one aspect of the present disclosure, an insert for a turbocharger support housing is provided. The insert includes a main body having a first surface and a second surface. The first and second surfaces define a thickness of the main body therebetween. The main body is configured to mate with a wear prone surface of the turbocharger support housing. The insert also includes a plurality of projections extending from the second surface. Each of the plurality of projections has an opening communicating with the first surface and a bottom end of the projection, such that each of the plurality of projections is configured to correspond with a mounting bore on the wear prone surface.

In another aspect of the present disclosure, a method for repairing a turbocharger support housing is provided. The method includes machining the turbocharger support housing to remove damaged areas. The method also includes aligning an insert with respect to a wear prone surface of the turbocharger support housing. The insert includes a first surface and a second surface. The second surface of the insert is configured to face the wear prone surface. The method further includes coupling the insert with the wear prone surface of the turbocharger support housing. The method includes presenting the first surface of the insert for wear.

In yet another aspect of the present disclosure, a turbocharger support housing is provided. The turbocharger support housing includes a frame member configured to couple to a turbocharger. The turbocharger support housing also includes a wear prone surface located on the frame member. The turbocharger support housing further includes an insert coupled to the wear prone surface. The insert includes a main body having a first surface and a second surface. The first and second surfaces define a thickness of the main body therebetween. The main body is configured to mate with the wear prone surface of the turbocharger support housing. The insert also includes a plurality of projections extending from the second surface. Each of the plurality of projections has an opening communicating with the first surface and a bottom end of the projection, such that each of the plurality of projections is configured to correspond with a mounting bore on the wear prone surface.

Other features and aspects of this disclosure will be apparent from the following description and the accompanying drawings.

### BRIEF DESCRIPTION OF THE DRAWINGS

FIG. 1 is a perspective view of an exemplary turbocharger support housing depicting a wear prone surface of the turbocharger support housing, according to one embodiment of the present disclosure;

FIG. 2 is an exploded view of a pair of inserts and the turbocharger support housing, according to one embodiment of the present disclosure;

FIG. 3 is a perspective view of an exemplary insert, according to one embodiment of the present disclosure;

FIG. 4 is a perspective view of a reverse side of the insert of FIG. 3, according to one embodiment of the present disclosure; and

FIG. 5 is a method for repairing the turbocharger support housing, according to one embodiment of the present disclosure.

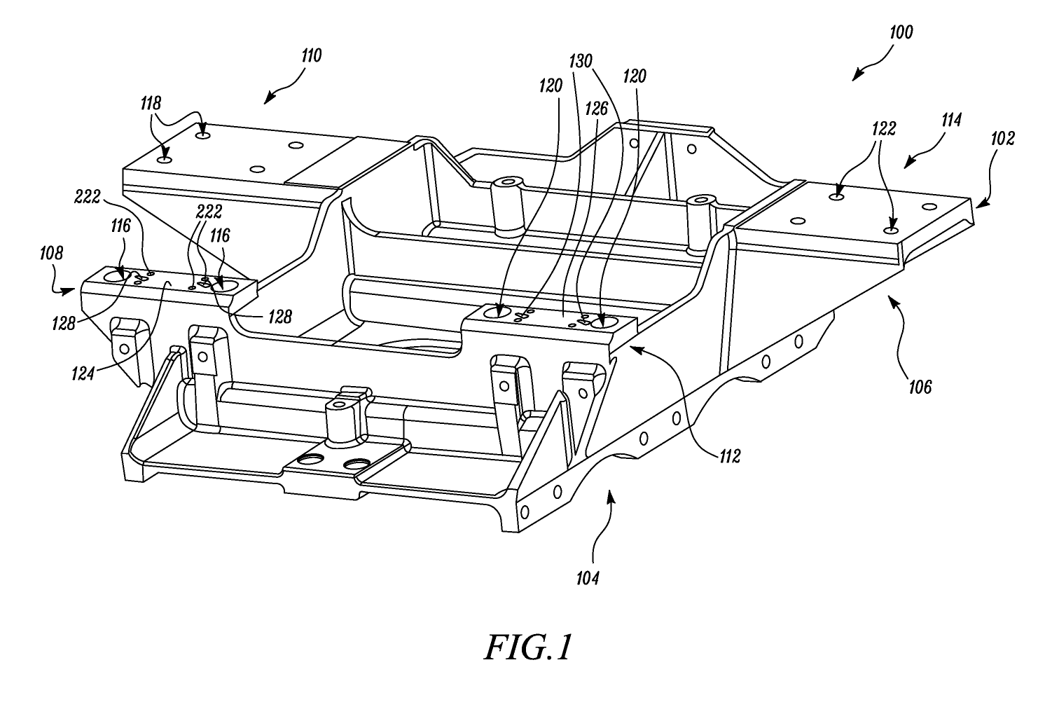

### DETAILED DESCRIPTION

Wherever possible, the same reference numbers will be used throughout the drawings to refer to the same or the like parts. FIG. 1 is a perspective view of an exemplary turbocharger support housing 100. The turbocharger support housing 100 is configured to support a turbocharger (not shown) associated with an engine (not shown). An assembly of the turbocharger and the turbocharger support housing 100 is in turn mounted on a machine surface (not shown), based on application requirements. The turbocharger is configured to increase an efficiency of the engine by forcing extra air into a combustion chamber of the engine. The turbocharger is generally powered by a turbine driven by exhaust gases exiting an exhaust manifold of the engine. The turbocharger may embody any known turbocharging system known in the art, and primarily includes components such as the turbine, a compressor, and a center housing/hub rotating assembly. The turbocharger may additionally include other components, without limiting the scope of the present disclosure.

Further, the engine equipped with the turbocharger may include a compression ignition engine to combust a mixture of air and diesel fuel. In alternative embodiments, the engine may include any other type of engines that may be used in association with a turbocharger. The engine may be configured for any suitable application such as motor vehicles, work machines, locomotives or marine engines, and in stationary applications such as electrical power generators.

The turbocharger is coupled to a frame member 102 of the turbocharger support housing 100 using mechanical fasteners (not shown). More particularly, the frame member 102 may include a first section 104 and a second section 106. The first section 104 may include a first mounting location 108 and a second mounting location 112. The second mounting section 106 may include a third mounting location 110 and a fourth mounting location 114. Each of the mounting locations 108, 110, 112, 114 includes mounting bores 116, 118, 120, 122. The mounting bores 116, 118, 120, 122 are configured to receive mechanical fasteners that secure the turbocharger to the turbocharger support housing 100.

During operation of the turbocharger, the first section 104 of the turbocharger support housing 100 can be subjected to high amounts of vibration and heat. In some examples, the vibration causes damage to a surface of the first and second mounting locations 108, 112 of the first section 104 of the turbocharger support housing 100. The first and second mounting locations 108, 112 of the turbocharger support housing 100 are thus prone to wear and may sometimes include damaged areas defined on generally planar mounting surfaces 124, 126 of the first and second mounting locations 108, 112. The mounting surfaces 124, 126 are hereinafter interchangeably referred to as wear prone surfaces 124, 126.

Each of the first and second mounting locations 108, 112 is subjected to wear, which may cause damage or wear marks 128, 130 on the wear prone surfaces 124, 126 of the first and second mounting locations 108, 112. In addition, due to vibrations generated during operation of the turbocharger, the mounting bores 116, 120 configured to receive the mechanical fasteners are subjected to elongation. The elongation of the mounting bores 116, 120 may affect the alignment of the turbocharger with the turbocharger support housing 100.

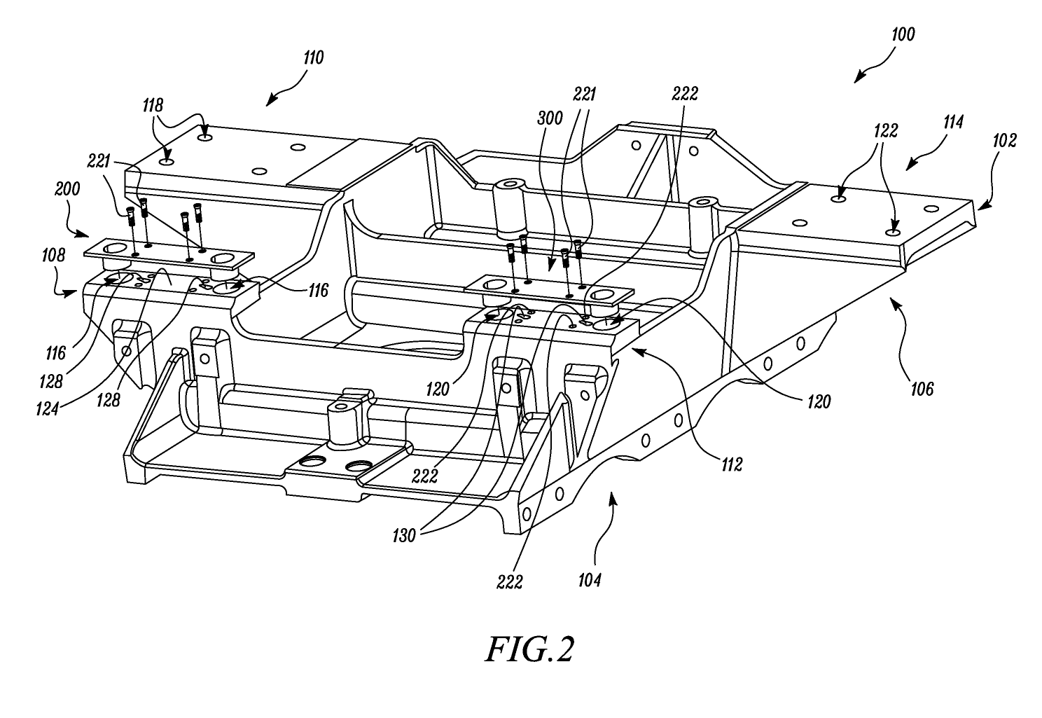

The present disclosure relates to an inserts 200, 300 configured to repair the first and second mounting locations 108, 112 of the turbocharger support housing 100, as best shown in FIGS. 2-4. When mounted on the damaged areas of the first and second mounting locations 108, 112, the inserts 200, 300 are configured to repair the first and second mounting locations 108, 112 and to protect the first and second mounting locations 108, 112 from future wear by presenting a sacrificial surface. The inserts 200, 300 are embodied as a unitary component, but it is also contemplated that the various parts of the insert 200, 300 may be assembled to form the insert 200, 300. As shown in FIG. 2, the inserts 200, 300 are aligned and coupled to the wear prone surfaces 124, 126 of the first and second mounting locations 108, 112.

The inserts 200, 300 associated with the first and second mounting locations 108, 112 have similar design features. Further, a material used to form the insert 200, 300 may be the same as a material of the turbocharger support housing 100. Alternatively, the material of the insert 200, 300 may be different from a material of the turbocharger support housing 100. The inserts 200, 300 may be made of a metal or a non-metal. In one example, the inserts 200, 300 may be made of a mild steel. Alternatively, the inserts 200, 300 may be made from stainless steel. The material of the insert 200, 300 is selected such that the material has high resistance to wear, corrosion, and high temperatures.

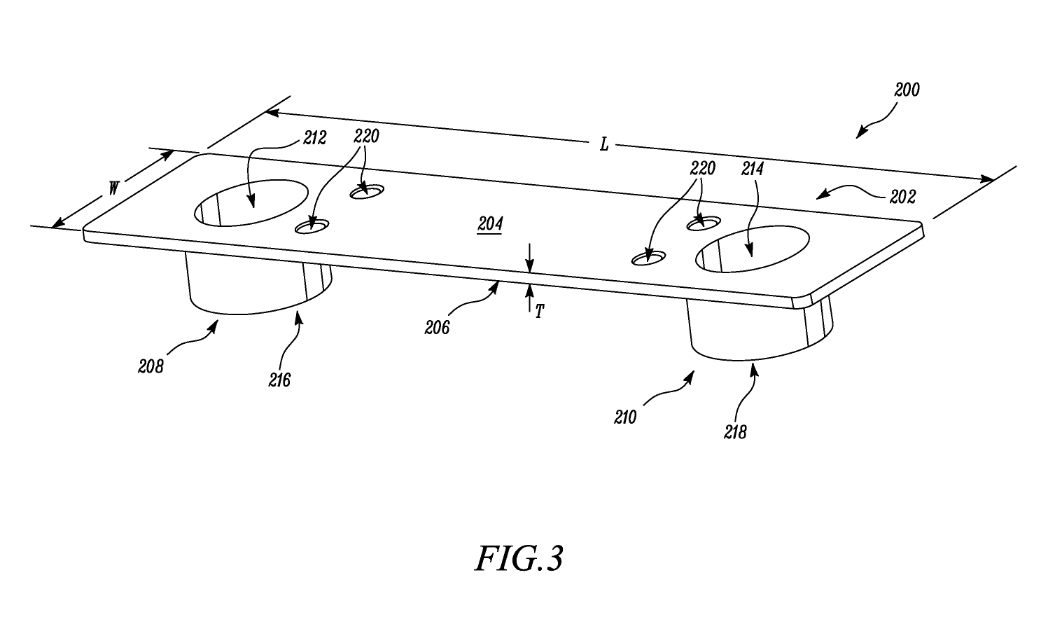

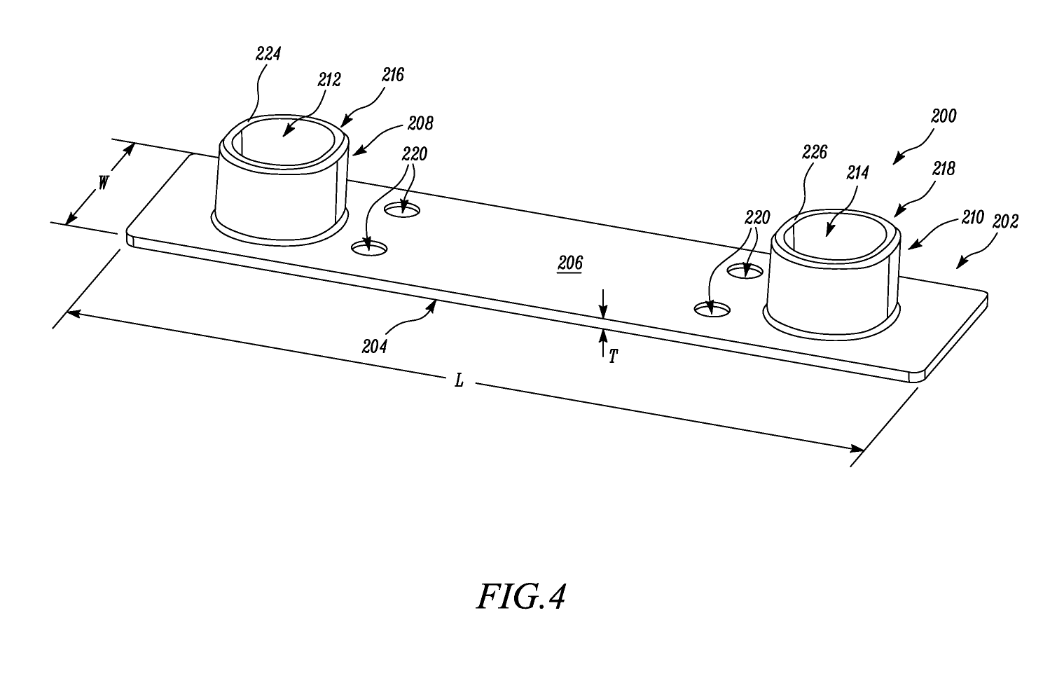

For illustrative and clarity purposes, the insert 200 coupled to the first mounting location 108 will now be explained in detail with reference to FIGS. 3 and 4. However, it should be noted that the description of the insert 200 given below is equally applicable to the insert 300 associated with the second mounting location 112, without limiting the scope of the present disclosure.

Referring to FIGS. 3 and 4, the insert 200 includes a main body 202. The main body 202 is configured to mate with the wear prone surface 124 of the turbocharger support housing 100. The main body 202 is generally rectangular in shape and includes a first surface 204 and a second surface 206 opposite the first surface 204 (see FIG. 4). The first surface 204 of the main body 202 presents a surface for wear when the insert 200 is coupled with the mounting surface 124. More particularly, the first surface 204 of the main body 202 contacts a portion of the turbocharger in operation. Further, the second surface 206 of the main body 202 faces the wear prone surface 124 (see FIG. 2). The first and second surfaces 204, 206 define a thickness “T” of the main body 202 therebetween.

The dimensions of the insert 200 may vary based on the size of the turbocharger support housing 100 and also based on the amount of wear experienced by the mounting surface 124 and the mounting bores 116. In one example, one or more parameters associated with the main body 202 are configured to match with the wear prone surface 124 of the turbocharger support housing 100. The one or more parameters may include at least one of the thickness “T”, a length “L”, and a width “W” of the main body 202.

The wear prone surfaces 124 may be machined before coupling of the insert 200 thereto. Hence, the thickness “T” of the main body 202 may be designed to compensate for the machining of the wear prone surface 124, such that after coupling of the insert 200 with the first mounting location 108, the dimensions of the wear prone surface 124 of the first mounting location 108 is restored to its original dimensions. Further, the length “L” and the width “W” of the insert 200 matches a length and a width of the wear prone surface 124 of the first mounting location 108.

The insert 200 includes a number of projections. In the illustrated example, the insert 200 includes a first projection 208 and a second projection 210. The first and second projections 208, 210 are configured to repair or restore the mounting bores 116 of the first mounting location 108 to its original dimensions. Each of the first and second projections 208, 210 correspond with the mounting bore 116 on the wear prone surface 124 of the first mounting location 108. More particularly, the first and second projections 208, 210 are configured to be aligned and received within the mounting bores 116 of the first mounting location 108. The first and second projections 208, 210 may have an oblong cross section corresponding to the profile of the mounting bores 116. The first and second projections 208, 210 may extend generally perpendicularly from the second surface 206 of the main body 202. Further, a thickness of a wall 224, 226 and/or a circumference of the first and second projections 208, 210 is based on the elongation of the mounting bores 116 and/or the amount of material that may be machined from the mounting bores 116 of the first mounting location 108.

Each of the first and second projections 208, 210 include an opening 212, 214. The opening 212, 214 is in communication with the first surface 204 and a bottom end 216, 218 of the respective first and second projections 208, 210. When the insert 200 is press fitted to the wear prone surface 124 and receives a portion of the turbocharger thereon, the opening 212, 214 of each of the first and second projections 208, 210 is configured to receive a mechanical fastener therethrough.

Referring to FIG. 4, the insert 200 includes a plurality of holes 220. In the illustrated example, the insert 200 includes four holes 220. However, the number of holes 220 may vary based on system requirements. The holes 220 are embodied as through holes. The holes 220 are configured to receive mechanical fasteners 221 (see FIG. 2). in order to couple the insert 200 to the wear prone surface 124. More particularly, the holes 220 are aligned with corresponding recesses 222 provided on the mounting surface 124 to receive the mechanical fasteners 221 (see FIG. 2). The mechanical fasteners 221 may include any one of a hole, bolt, pin, screw, rivet, and the like. The recesses 222 on the wear prone surface 124 may be machined into the mounting surface 124 using any material removal process known in the art.

Referring to FIGS. 2 to 4, each of the holes 220 are aligned with the recesses 222 to receive the mechanical fasteners 221 (see FIG. 2) to facilitate attachment of the insert 200 over the wear prone surface 124 of the first mounting location 108. Further, the first and second projections 208, 210 are aligned with the mounting bores 116 at the first mounting location 108. The insert 200 may be coupled to the wear prone surface 124 of the first mounting location 108 by a press fit. Optionally, an adhesive may also be provided between the wear prone surface 124 and the second surface 206 of the insert 200 to further enhance the coupling between the insert 200 and the wear prone surface 124 of the first mounting location 108.

### INDUSTRIAL APPLICABILITY

The present disclosure describes the insert 200, 300 to repair the mounting surfaces 124, 126 and the mounting bores 116, 120 of the turbocharger support housing 100. The insert 200, 300 is embodied as a unitary solution for repairing both the mounting surfaces 124, 126 and the mounting bores 116, 120 extending from the mounting surfaces 124, 126. The insert 200, 300 is easy to manufacture, and any additive or subtractive manufacturing known in the art process may be used to manufacture the insert 200, 300. The insert 200, 300 provides a cost effective and easy to apply repair solution. The dimensions of the insert 200, 300 may be varied based on the type of application. Further, it is also contemplated that the insert 200, 300 may also be coupled to the mounting surface 124, 126 during first assembly as a measure against wear and erosion.

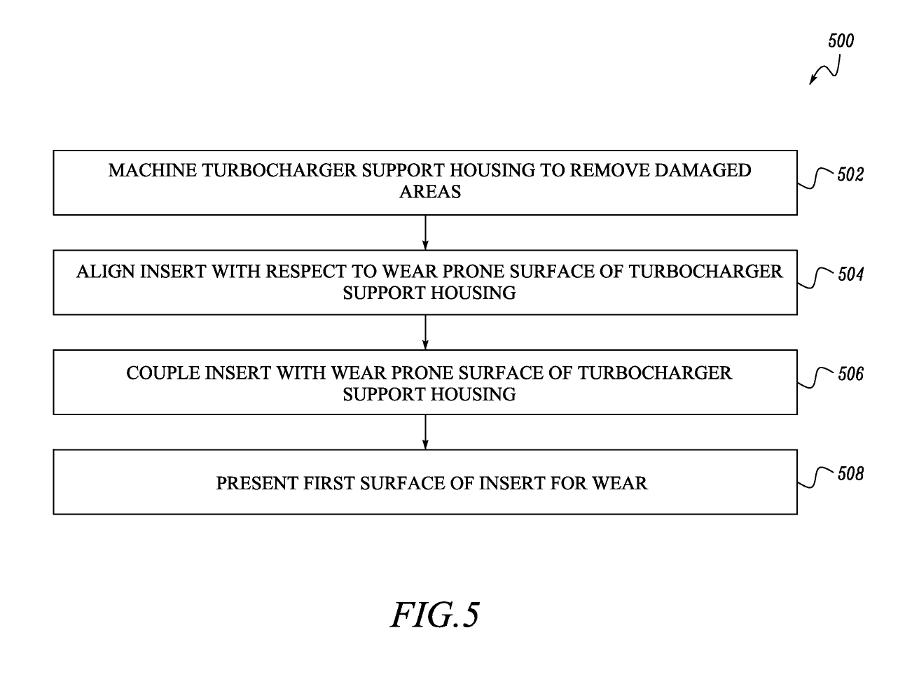

FIG. 5 is a flowchart for a method 500 of repairing the turbocharger support housing 100. The method 500 will be explained with reference to the insert 200 coupled to the mounting surface 124 for the purpose of simplicity, but the method 500 is also applicable to the insert 300 coupled to the mounting surface 126 without any limitations. At step 502, the turbocharger support housing 100 is machined to remove the damaged areas. More particularly, the generally planar mounting surface 124 of the first mounting location 108 and the mounting bore 116 extending from the mounting surface 124 are machined to remove worn or otherwise damaged areas.

At step 504, the insert 200 is aligned with respect to the wear prone surface 124 of the turbocharger support housing 100. The insert 200 includes the first and second surfaces 204, 206, wherein the second surface 206 of the insert 200 is configured to face the wear prone surface 124. Further, the projections 208, 210 extending from the second surface 206 of the insert 200 are also aligned with the corresponding mounting bores 116 provided on the wear prone surface 124.

At step 506, the insert 200 is coupled with the wear prone surface 124 of the turbocharger support housing 100. For the coupling of the insert 200, the holes 220 provided on the insert 200 are aligned with the recesses 222 to receive the mechanical fasteners 221, in order to couple the insert 200 with the wear prone surface 124. At step 508, the first surface 204 of the insert 200 is presented for wear.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An insert for a turbocharger support housing, the insert comprising:
a main body having a first surface and a second surface, the first and second surfaces defining a thickness therebetween, wherein the main body is configured to mate with a wear prone surface of the turbocharger support housing; and
a plurality of projections extending from the second surface, wherein each of the plurality of projections has an opening communicating with the first surface and a bottom end of the projection, such that each of the plurality of projections is configured to correspond with a mounting bore on the wear prone surface.

2. The insert of claim 1, wherein a length, and a width of the main body matches a length and width of the wear prone surface of the turbocharger support housing.

3. The insert of claim 1, wherein the opening of each of the plurality of projections is configured to receive a mechanical fastener therethrough.

4. The insert of claim 1, wherein each of the plurality of projections extend generally perpendicularly from the second surface.

5. The insert of claim 1 further comprising:
a plurality of holes configured to receive mechanical fasteners to couple the insert to the wear prone surface.

6. The insert of claim 5, wherein each of the plurality of holes is configured to be aligned with a corresponding recess to receive the mechanical fasteners for coupling the insert with the wear prone surface by press fitting.

7. The insert of claim 1, wherein the first surface is configured to present a surface for wear.

8. The insert of claim 1, wherein a material used to form the insert is same as a material of the turbocharger support housing.

9. The insert of claim 1, wherein a material used to form the insert is different from a material of the turbocharger support housing.

10. A method for repairing a turbocharger support housing, the method comprising:
machining the turbocharger support housing to remove damaged areas;
aligning an insert with respect to a wear prone surface of the turbocharger support housing, the insert having a first surface and a second surface, wherein the second surface of the insert is configured to face the wear prone surface;
coupling the insert with the wear prone surface of the turbocharger support housing; and
presenting the first surface of the insert for wear.

11. The method of claim 10, wherein machining further comprises:
machining a generally planar mounting surface of a turbo mounting location and machining a mounting bore extending from the mounting surface.

12. The method of claim 10, wherein the aligning further comprises:
coaxially aligning a plurality of projections extending from the second surface of the insert with corresponding mounting bores provided on the wear prone surface.

13. The method of claim 10, wherein the coupling further comprises:
aligning the plurality of holes with the corresponding recesses in order to couple the inert with the wear prone surface.

14. A turbocharger support housing comprising:
a frame member configured to couple to a turbocharger;
a wear prone surface located on the frame member; and
an insert coupled to the wear prone surface, the insert comprising:
a main body having a first surface and a second surface, the first and second surfaces defining a thickness therebetween, wherein the main body is configured to mate with the wear prone surface of the turbocharger support housing; and
a plurality of projections extending from the second surface, wherein each of the plurality of projections has an opening communicating with the first surface and a bottom end of the projection and each of the plurality of projections is received into a corresponding mounting bore on the wear prone surface.

15. The turbocharger support housing of claim 14, wherein a length, and a width of the main body of the insert substantially matches a length and width of the wear prone surface.

16. The turbocharger support housing of claim 14, wherein the opening of each of the plurality of projections receives a mechanical fastener therethrough.

17. The turbocharger support housing of claim 14, wherein each of the plurality of projections extends generally perpendicularly from the second surface.

18. The turbocharger support housing of claim 14, wherein the insert further comprises a plurality of holes.

19. The turbocharger support housing of claim 18, wherein each of the plurality of holes is aligned with a corresponding recess in order to couple the inert with the wear prone surface.
